(19) United States
(12) Patent Application Publication
(10) Pub. No.: US 2024/0405252 A1
(43) Pub. Date: Dec. 5, 2024

(54) POWER STORAGE CELL

(71) Applicant: Toyota Jidosha Kabushiki Kaisha, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: Toyota Jidosha Kabushiki Kaisha, Toyota-shi (JP)

(21) Appl. No.: 18/630,763

(22) Filed: Apr. 9, 2024

(30) Foreign Application Priority Data
May 29, 2023 (JP) 2023-087790

(51) Int. Cl. H01M 10/04; H01M 4/04; H01M 50/107

(52) U.S. Cl. CPC H01M 10/0431; H01M 4/0404; H01M 50/107

(57) ABSTRACT

A power storage cell includes a wound electrode assembly which includes: a positive plate (a first electrode); a negative plate (a second electrode); and a separator, and a securing member for securing the wound electrode assembly so that the wound electrode assembly is maintained in a wound state. The wound electrode assembly includes an end surface (a first end surface) on one side in Z direction (axial direction) in which a winding axis extends, and an end surface (a second end surface) on the other side in Z direction. The securing member is disposed on at least on the end surface.

### CROSS REFERENCE TO RELATED APPLICATIONS

This nonprovisional application is based on Japanese Patent Application No. 2023-087790 filed on May 29, 2023 with the Japan Patent Office, the entire content of which is hereby incorporated by reference.

### BACKGROUND OF THE DISCLOSURE

### Field of the Disclosure

The present disclosure relates to a power storage cell.

### Description of the Background Art

WO2018/105398 discloses a secondary battery that includes an electrode assembly in which a positive electrode and a negative electrode are wound in a spiral manner with a separator in between. A tape is applied to an outer circumferential surface of the electrode assembly for securing a winding finish end. The electrode assembly is accommodated in a case.

### SUMMARY OF THE DISCLOSURE

According to WO2018/105398, in order to restrict the movement of the electrode assembly, the space between the outer circumferential surface of the electrode assembly and the inner circumferential surface of the case is small. Due to this, the tape and the case interfere as the electrode assembly expands or the like, producing a local pressure at the electrode assembly where the tape is applied.

The present disclosure is made to solve the above problem, and an object of the present disclosure is to provide a power storage cell that can maintain the wound electrode assembly in the wound state, while inhibiting a local pressure from being produced at the wound electrode assembly.

A power storage cell according to the aspect includes: a wound electrode assembly which includes a first electrode, a second electrode, and a separator disposed between the first electrode and the second electrode; and a securing member for securing the wound electrode assembly so that the wound electrode assembly is maintained in a wound state. The wound electrode assembly is configured of the first electrode, the second electrode, and the separator being wound about a winding axis. The wound electrode assembly includes a first end surface on one side in an axial direction in which the winding axis extend, and a second end surface on the other side in the axial direction. The securing member is disposed at least on the first end surface.

In the power storage cell according to the aspect, the securing member is disposed on the first end surface as described above. This allows the wound electrode assembly to be maintained in the wound state by the securing member on the first end surface, without having to apply a tape to the side surface of the wound electrode assembly for securing the wound electrode assembly. As a result, the wound electrode assembly can be maintained in the wound state, while inhibiting a local pressure from being produced at the wound electrode assembly caused by the application of a tape.

In the power storage cell according to the aspect, preferably, the securing member is disposed also on the second end surface. With this configuration, the wound electrode assembly can be maintained in the wound state by using the securing member on the second end surface, in addition to the securing member on the first end surface. This allows more rigidly maintaining the wound electrode assembly in the wound state.

In the power storage cell according to the aspect, preferably, the wound electrode assembly includes a peripheral surface between the first end surface and the second end surface. The securing member is disposed closer to the peripheral surface than the winding axis. With this configuration, the securing member is disposed on a radially outward portion of the wound electrode assembly, thereby inhibiting the wound electrode assembly from being unwound, starting from radially outside.

In this case, preferably, the securing member extends along a radial direction of the wound electrode assembly between the winding axis α nd the peripheral surface. With this configuration, the securing member can have an increased radial length, thereby more rigidly maintaining the wound electrode assembly in the wound state. The radially inward portion of the wound electrode assembly can also be readily secured by the securing member, as compared to the securing member not extending in the radial direction. This can inhibit the wound electrode assembly from being unwound, starting from radially inside during handling of the wound electrode assembly, etc.

The power storage cell, in which the securing member extends along the radial direction, further includes a case for accommodating the wound electrode assembly, the case having a cylindrical shape. The securing member has a length, in the radial direction, less than or equal to a radius of the case. With this configuration, even if two securing members are aligned along the radial direction, the securing members can be prevented from interfering with the case.

In the power storage cell according to the aspect, preferably, the wound electrode assembly includes a termination portion where winding of the wound electrode assembly terminates. The securing member is disposed on the termination portion. With this configuration, the wound electrode assembly can be inhibited from being unwound, starting from the termination portion.

In the power storage cell according to the aspect, preferably, as viewed from the axial direction, the wound electrode assembly includes an exposed portion where no securing member is disposed. With this configuration, With this configuration, when an electrolyte solution is injected into the wound electrode assembly in the axial direction, the flow of the electrolyte solution can be better prevented from being blocked by the securing member than the case where the securing member covers across (the entirety of) the wound electrode assembly.

In the power storage cell according to the aspect, preferably, the securing member includes a base member and an adhesive layer disposed on the base member. The base member is formed of an elastically deformable resin. With this configuration, the base member can be elastically deformed as the first electrode expands in the axial direction. This can inhibit the base member from cracking.

In the power storage cell according to the aspect, preferably, the first electrode includes a first current collector and a first electrode material layer with which a portion of the first current collector is coated, the first electrode material layer facing the separator in a radial direction of the wound electrode assembly. The first current collector has: a first coated portion that is coated with the first electrode material layer; and a first uncoated portion that is not coated with the first electrode material layer, the first uncoated portion being located closer to the one side in the axial direction than the first coated portion. The securing member is disposed on the first end surface formed of the first uncoated portion. With this configuration, owing to the securing member being disposed on the first uncoated portion that is not coated with the first electrode material layer, a load caused by the securing member can be prevented from being applied to the first electrode material layer upon expansion of the wound electrode assembly.

In the power storage cell according to the aspect, preferably, the second electrode includes a second current collector and a second electrode material layer with which a portion of the second current collector is coated, the second electrode material layer facing the separator in a radial direction of the wound electrode assembly. The second current collector has: a second coated portion that is coated with the second electrode material layer; and a second uncoated portion that is not coated with the second electrode material layer, the second uncoated portion being located closer to the other side in the axial direction than the second coated portion. The securing member is disposed on the second end surface formed of the second uncoated portion. With this configuration, owing to the securing member being disposed on the second uncoated portion that is not coated with the second electrode material layer, a load caused by the securing member can be prevented from being applied to the second electrode material layer upon expansion of the wound electrode assembly.

According to the present disclosure, the wound electrode assembly is maintained in the wound state, while inhibiting a local pressure from being produced at the wound electrode assembly.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view showing a configuration of a power storage cell according to an embodiment.

FIG. 2 is a schematic perspective view showing a configuration of a wound electrode assembly according to the embodiment.

FIG. 3 is an enlarged partial view of the positive side of the power storage cell of FIG. 1.

FIG. 4 is an enlarged partial view of the negative side of the power storage cell of FIG. 1.

FIG. 5 is a perspective view showing a configuration of the wound electrode assembly according to the embodiment.

FIG. 6 is a plan view of the wound electrode assembly according to the embodiment, as viewed from Z1 side.

FIG. 7 is a plan view of the wound electrode assembly according to the embodiment, as viewed from Z2 side.

FIG. 8 is a cross-sectional view of the wound electrode assembly according to the embodiment, taken long VIII-VIII line of FIG. 5.

FIG. 9 is a cross-sectional view of the wound electrode assembly according to the embodiment, taken long IX-IX line of FIG. 5.

FIG. 10 is a plan view of the wound electrode assembly according to Variation 1 of the embodiment, as viewed from Z1 side.

FIG. 11 is a plan view of the wound electrode assembly according to Variation 2 of the embodiment, as viewed from Z1 side.

FIG. 12 is a plan view of the wound electrode assembly according to Variation 3 of the embodiment, as viewed from Z1 side.

FIG. 13 is a plan view of the wound electrode assembly according to Variation 4 of the embodiment, as viewed from Z1 side.

FIG. 14 is a side view of the wound electrode assembly according to Variation 5 of the embodiment, as viewed from radially outside.

FIG. 15 is a side view of the wound electrode assembly according to Variation 6 of the embodiment, as viewed from radially outside.

FIG. 16 is a perspective view of the wound electrode assembly according to Variation 7 of the embodiment.

### DESCRIPTION OF THE PREFERRED EMBODIMENTS

Hereinafter, an embodiment according to the present disclosure will be described, with reference to the accompanying drawings. Note that like reference signs are used to refer to like or corresponding parts in the drawings, and the description thereof will not be repeated.

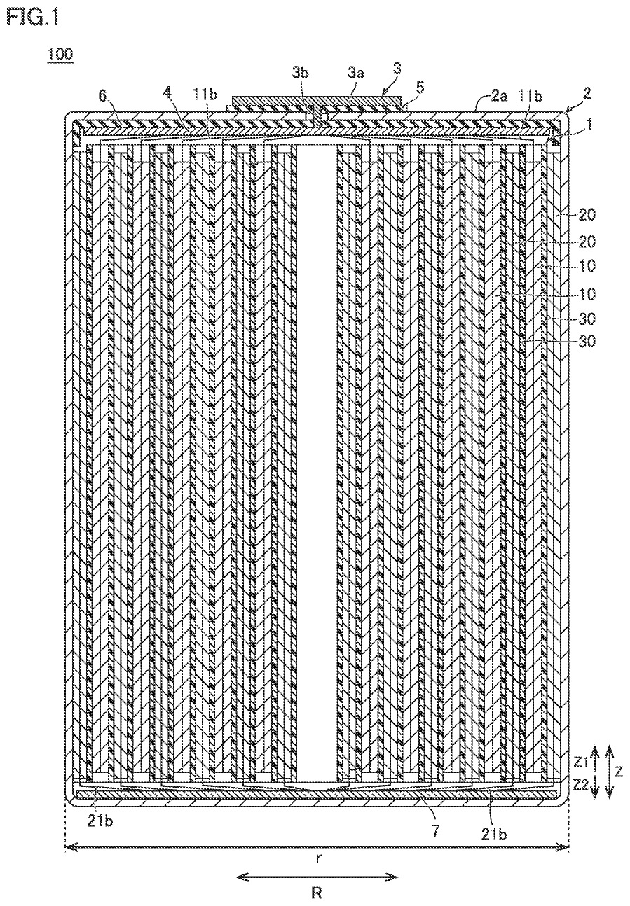

FIG. 1 is a cross-sectional view showing a general configuration of a power storage cell 100 according to an embodiment of the present disclosure. The power storage cell 100 is, for example, a lithium-ion battery that is mounted on a vehicle. Note that the application and type of the power storage cell 100 are not limited thereto.

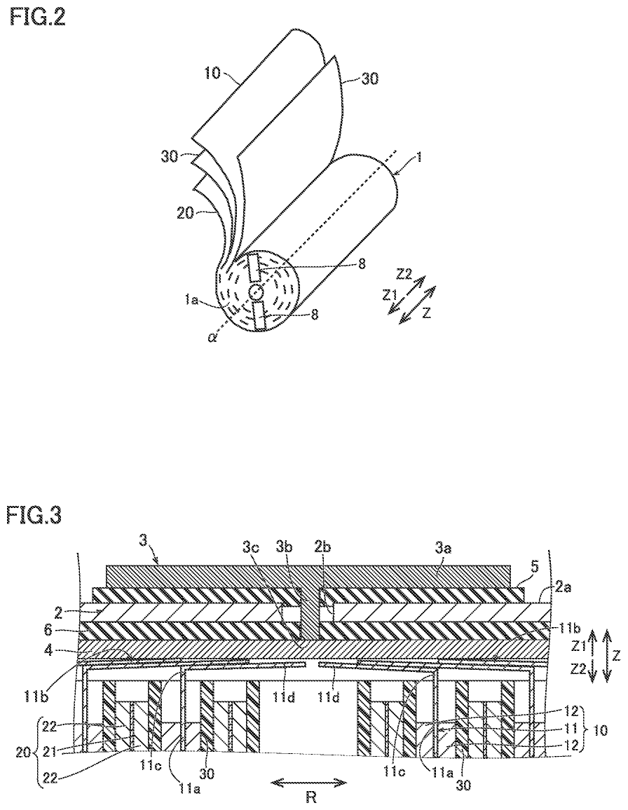

The power storage cell 100 includes a wound electrode assembly 1, a case 2, a positive terminal 3, a positive current collector plate 4, an external gasket 5, an internal gasket 6, and a negative current collector plate 7, and a securing member 8 (see FIG. 2). Note that FIG. 1 is a cross-sectional view of the power storage cell 100 as viewed in the direction where the securing member 8 is not seen.

The wound electrode assembly 1 is accommodated in the case 2. The case 2 has a cylindrical shape. In other words, the power storage cell 100 is a cylindrical battery. Note that the case 2 is formed of copper or aluminum, for example.

The wound electrode assembly 1 includes positive plates 10, negative plates 20, and separators 30. The separator 30 is disposed between the positive plate 10 and the negative plate 20. The separator 30 separates the positive plate 10 and the negative plate 20, while allowing ions (e.g., lithium-ions) to traverse between the positive plate 10 (a positive active material) and the negative plate 20 (a negative active material). The wound electrode assembly 1 is configured of a group of electrode plates in which the positive plate 10 and the negative plate 20 are wound via the separator 30. Note that the positive plate 10 and the negative plate 20 are one example of a “first electrode” and a “second electrode,” respectively, according to the present disclosure.

As shown in FIG. 2, the wound electrode assembly 1 configured of the positive plate 10, the negative plate 20, and the separator 30 being wound about a winding axis α of the wound electrode assembly 1. In FIG. 2, the wound electrode assembly 1 is shown, being slightly unwound so that the wound state of the wound electrode assembly 1 is intelligible.

Referring, again, to FIG. 1, the positive terminal 3 includes a disk portion 3a and a riveting portion 3b. The riveting portion 3b is connected to the disk portion 3a. The riveting portion 3b extends from the center of the disk portion 3a to Z2 side. Note that the positive terminal 3 is formed of aluminum.

As shown in FIG. 3, the disk portion 3a is disposed on an upper surface 2a (the Z1-side surface) of the case 2. The upper surface 2a of the case 2 has a through hole 2b. The riveting portion 3b extends from the disk portion 3a, disposed outside the case 2, into the case 2 through the through hole 2b.

The positive current collector plate 4 is accommodated in the case 2. On Z1 side of the wound electrode assembly 1, the positive current collector plate 4 is welded to a positive uncoated portion 11b (described below) of the positive plate 10. This causes the positive current collector plate 4 to be positively charged. The positive current collector plate 4 is welded to an end 3c of the riveting portion 3b on Z2 side. This causes the positive terminal 3 to be positively charged.

The external gasket 5 is disposed between the disk portion 3a of the positive terminal 3 and the upper surface 2a of the case 2. This electrically insulates the positive terminal 3 from the case 2.

The internal gasket 6 is disposed in the case 2 between the case 2 and the positive current collector plate 4. This electrically insulates the case 2 from the positive current collector plate 4. Note that the riveting portion 3b passes through the internal gasket 6 and is thereby in contact with the positive current collector plate 4.

The positive plate 10 includes a positive current collector 11 and a positive electrode mixture layer 12. The positive electrode mixture layer 12 is applied to radially (R direction) opposite surfaces of the positive current collector 11 (a positive coated portion 11a described below). The positive electrode mixture layer 12 faces the separator 30 in R direction. Note that the positive current collector 11 and the positive electrode mixture layer 12 are one example of a “first current collector” and a “first electrode material layer,” respectively, according to the present disclosure.

For example, aluminum is used for the positive current collector 11. The positive electrode mixture layer 12 is formed by coating a surface of the positive current collector 11 with a cathode slurry and drying. The cathode slurry is prepared by mixing the materials (such as a positive active material and a binder) of the positive electrode mixture layer 12 and a solvent. The positive electrode mixture layer 12 is appressed to the separator 30 (see FIG. 1). The positive electrode mixture layer 12 has a thickness greater than or equal to 0.1 μm and less than or equal to 1000 μm, for example.

The positive current collector 11 includes a positive coated portion 11a and a positive uncoated portion 11b. The positive coated portion 11a is a portion of the positive current collector 11 that is coated with the positive electrode mixture layer 12. The positive coated portion 11a is sandwiched between the separators 30. Note that the positive coated portion 11a and the positive uncoated portion 11b are one example of a “first coated portion” and a “first uncoated portion,” respectively, according to the present disclosure.

The positive uncoated portion 11b is a portion of the positive current collector 11 that is not coated with the positive electrode mixture layer 12. The positive uncoated portion 11b is located more to Z1 side than the positive coated portion 11a is. Specifically, the positive uncoated portion 11b projects from the positive coated portion 11a to Z1 side. Note that Z1 side is one example of “one side in an axial direction” according to the present disclosure.

The positive uncoated portion 11b includes a portion 11c extending along Z direction and a portion 11d extending along R direction. The positive uncoated portion 11b is bent radially inward. The positive uncoated portion 11b is bent in an L shape. The portion 11d of the positive uncoated portion 11b is in contact with the positive current collector plate 4. This causes the positive current collector plate 4 to be positively charged. Note that the positive uncoated portion 11b (the portion 11d) is joined to the positive current collector plate 4 by welding.

Multiple positive uncoated portions 11b are aligned in the winding direction. A slit 11g (see FIG. 5) is formed between the positive uncoated portions 11b that are adjacent to each other in the winding direction. Among the positive uncoated portion 11b, the positive uncoated portions 11b that are adjacent to each other in R direction partially overlap.

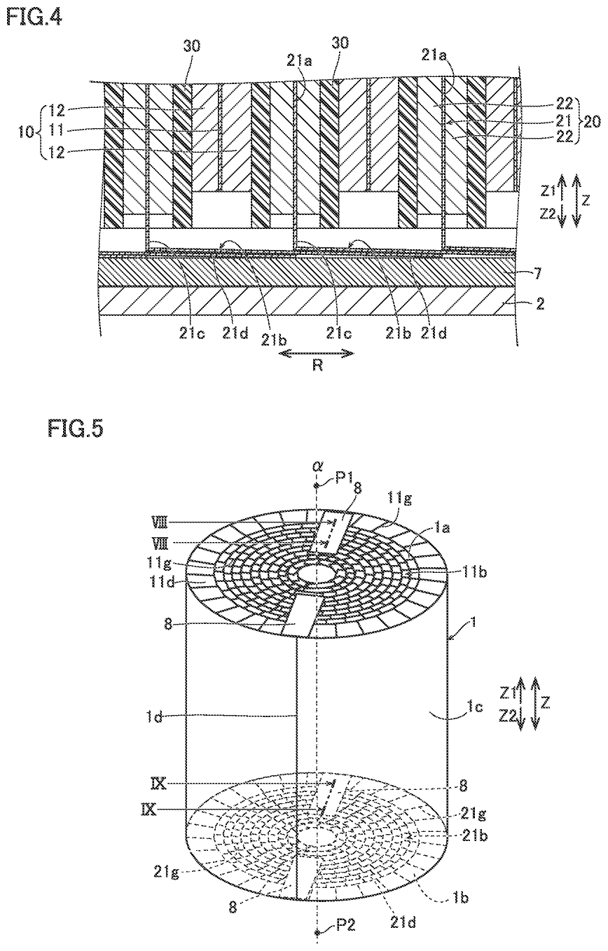

As shown in FIG. 4, the negative current collector plate 7 is accommodated in the case 2. The negative current collector plate 7 is welded to a negative uncoated portion 21b of the negative plate 20 (described below) on Z2 side of the wound electrode assembly 1. This causes the negative current collector plate 7 to be negatively charged. Note that the negative current collector plate 7 is in contact with the case 2. This causes the case 2 to be negatively charged.

The negative plate 20 includes a negative current collector 21 and a negative electrode mixture layer 22. The negative electrode mixture layer 22 is applied to radially (R direction) opposite surfaces of the negative current collector 21 (a negative coated portion 21a described below). The negative electrode mixture layer 22 faces the separator 30 in R direction. Note that the negative current collector 21 and the negative electrode mixture layer 22 are one example of a “second current collector” and a “second electrode material layer,” respectively, according to the present disclosure.

For example, copper is used for the negative current collector 21. The negative electrode mixture layer 22 is formed by coating a surface of the negative current collector 21 with an anode slurry and drying. The anode slurry is prepared by mixing the materials (such as a negative active material and a binder) of the negative electrode mixture layer 22 and a solvent. The negative electrode mixture layer 22 is appressed to the separator 30. The negative electrode mixture layer 22 has a thickness greater than or equal to 0.1 μm and less than or equal to 1000 μm, for example.

The negative current collector 21 includes a negative coated portion 21a and a negative uncoated portion 21b. The negative coated portion 21a is a portion of the negative current collector 21 that is coated with the negative electrode mixture layer 22. The negative coated portion 21a is sandwiched between the separators 30. Note that the negative coated portion 21a and the negative uncoated portion 21b are one example of a “second coated portion” and a “second uncoated portion,” respectively, according to the present disclosure.

The negative uncoated portion 21b is a portion of the negative current collector 21 that is not coated with the negative electrode mixture layer 22. The negative uncoated portion 21b is located more to Z2 side than the negative coated portion 21a is. Specifically, the negative uncoated portion 21b projects from the negative coated portion 21a to Z2 side. Note that Z2 side is one example of “the other side in the axial direction” according to the present disclosure.

The negative uncoated portion 21b includes a portion 21c extending along Z direction and a portion 21d extending along R direction. The negative uncoated portion 21b is bent radially inward. The negative uncoated portion 21b is bent in an L shape. The portion 21d of the negative uncoated portion 21b is in contact with the negative current collector plate 7. This causes the negative current collector plate 7 to be negatively charged. Note that the negative uncoated portion 21b (the portion 21d) is joined to the negative current collector plate 7 by welding.

Multiple negative uncoated portions 21b are aligned along the winding direction. A slit 21g (see FIG. 5) is formed between the negative uncoated portions 21b that are adjacent to each other in the winding direction. Among the negative uncoated portion 21b, the negative uncoated portions 21b that are adjacent to each other in R direction partially overlap.

As shown in FIG. 5, the wound electrode assembly 1 includes an end surface 1a, an end surface 1b, a peripheral surface 1c, and a termination portion 1d. The end surface 1a is the Z1-side end surface of the wound electrode assembly 1. The end surface 1b is the Z2-side end surface of the wound electrode assembly 1. The peripheral surface 1c is an outer circumferential surface of the wound electrode assembly 1 between the end surface 1a and the end surface 1b. The termination portion 1d is where the winding of the wound electrode assembly terminates.

Here, with a configuration of a conventional power storage cell, a tape for securing a wound electrode assembly may be applied to the side surface of the wound electrode assembly in order to maintain the wound electrode assembly in the wound state. Moreover, in order to restrict the movement of the wound electrode assembly, the space between the side surface of the wound electrode assembly and the inner circumferential surface of the case is small. Due to this, as the wound electrode assembly expands or the like, the tape interferes with the case, producing a local pressure at the wound electrode assembly where the tape is applied.

Thus, in the present embodiment, the securing members 8 are disposed on the end surface 1a, as shown in FIGS. 2 and 5. The securing member 8 is a member for securing the wound electrode assembly 1 so that the wound electrode assembly 1 can be maintained in the wound state. The end surface 1a is formed of the positive uncoated portions 11b wound about the winding axis α.

In other words, the securing members 8 are disposed on the positive uncoated portions 11b. Specifically, the securing members 8 are disposed on the portions 11d, among the positive uncoated portions 11b.

Two securing members 8 are disposed on the end surface 1a. The two securing members 8 on the end surface 1a are provided on the opposite sides (facing) about the winding axis α. In other words, the two securing members 8 on the end surface 1a lie on a straight line passing through the winding axis α.

The securing members 8 are also disposed on the end surface 1b. The end surface 1b is formed of the negative uncoated portions 21b wound about the winding axis α. In other words, the securing members 8 are disposed on the negative uncoated portions 21b. Specifically, the securing members 8 are disposed on the portions 21d, among the negative uncoated portions 21b.

Two securing members 8 are disposed on the end surface 1b. The two securing members 8 on the end surface 1b are provided on the opposite sides about the winding axis α. In other words, the two securing members 8 on the end surface 1b lie on a straight line passing through the winding axis α.

Note than one or three or more securing members 8 may be disposed on each of the end surface 1a and the end surface 1b. Moreover, the number of securing members 8 disposed on the end surface 1a may differ from the number of securing members 8 disposed on the end surface 1b.

The securing members 8 on the end surface 1a are disposed overlapping (being coincide with) the securing members 8 on the end surface 1b in Z direction. One of the two securing members 8 on each of the end surface 1a and the end surface 1b is disposed on the termination portion 1d. Specifically, the securing member 8 and the termination portion 1d overlap (are adjacent to each other) in the radial direction (R direction) of the wound electrode assembly 1, as viewed from Z1 side. Note that the securing member 8 may not overlap the termination portion 1d in the radial direction of the wound electrode assembly 1, and may instead be disposed in the vicinity of the termination portion 1d in the circumference direction.

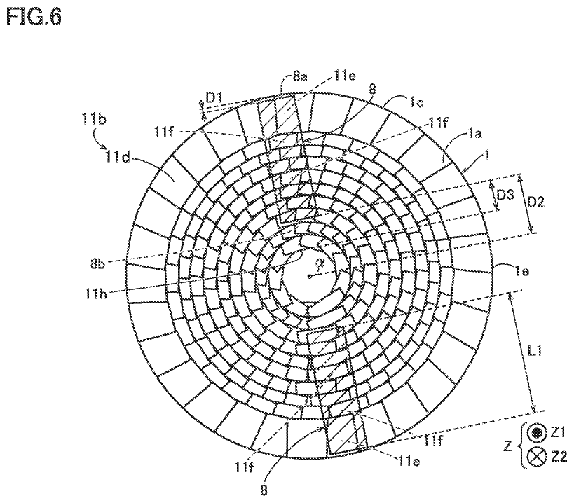

As shown in FIG. 6, the securing members 8 are attached to portions 11e that are on an outer periphery 1e of the wound electrode assembly 1, among the positive uncoated portions 11b (the portions 11d). In other words, the portions 11e are the positive uncoated portions 11b that are projecting, to Z1 side, from the positive coated portions 11a of the positive current collectors 11 that are wound on the radially outermost side of the wound electrode assembly 1. Note that FIG. 6 shows the securing members 8 in hatch patterns.

The securing members 8, as viewed from Z1 side, are also attached to multiple portions 11f, which are aligned radially inward relative to the portions 11e, among the positive uncoated portions 11b (the portions 11d). The portion 11f is the positive uncoated portion 11b that is projecting, to Z1 side, from the positive coated portion 11a that is wound radially inward than the positive coated portion 11a that is wound on the radially outermost side of the wound electrode assembly 1. In other words, the portion 11f projects from the positive coated portion 11a at a location more proximate to the winding axis α than a location at which the portion 11e projects from the positive coated portion 11a.

The securing members 8 are disposed across the radially aligned portion 11e and multiple portions 11f. This causes the portion 11e and the portions 11f to be adhered to each other by an adhesive layer 8d described below. Note that the positive uncoated portions 11b (the portion 11e and the portion 11f/the portions 11f) that are adjacent to each other in the radial direction partially overlap in Z direction.

The securing members 8 extend along the radial direction of the wound electrode assembly 1, between the winding axis α and the peripheral surface 1c (the outer periphery 1e of the wound electrode assembly 1). The securing members 8 extend radially inward, from the portion 11e. The securing member 8 has a rectangular shape having the long sides extending in the radial direction (see FIG. 6). Note that when the case 2 has a diameter r (see FIG. 1) of, for example, 46 mm, preferably, the securing member 8 has a length L1 (see FIG. 6), in the radial direction, which is greater than or equal to 1 mm and less than or equal to 23 mm (i.e., less than or equal to the diameter of the case 2). This can prevent the securing member 8 from interfering with the case 2. Note that the diameter r may be the outer diameter of the case 2.

The securing members 8 are disposed closer to the peripheral surface 1c than the winding axis α. Specifically, a distance D1 between a radially outward end 8a of the securing member 8 and the peripheral surface 1c (the outer periphery 1e), as viewed from one side in the axial direction (Z1 side), is less than a distance D2 between a radially inward end 8b of the securing member 8 and the winding axis α. The distance D1, as viewed from Z1 side, is less than a distance D3 between an inner periphery 11h of the end surface 1a and the end 8b. Note that “as viewed from Z1 side” described above means viewing the wound electrode assembly 1 from a point P1 (see FIG. 5) on the winding axis α on Z1 side of the wound electrode assembly 1.

As can be understood from the above description, the wound electrode assembly 1, as viewed along the axial direction, includes an exposed portion where no securing member 8 is disposed. In other words, the securing members 8 are disposed on a portion of the wound electrode assembly 1 as viewed Z1 side. In the example shown in FIG. 6, the exposed portion refers to a portion of the wound electrode assembly 1, other than an area in which the securing members 8 are disposed.

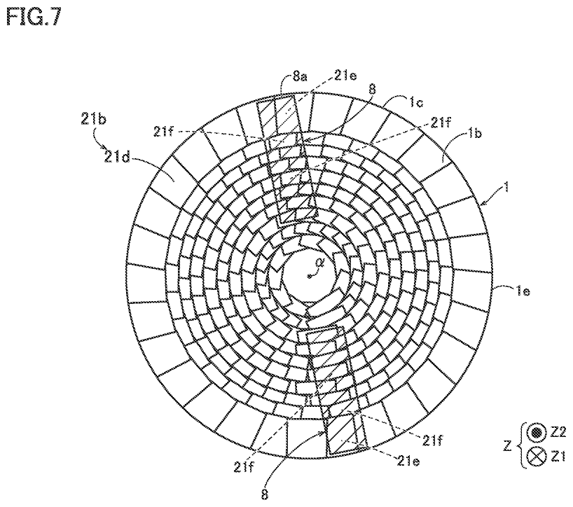

The negative side of the power storage cell 100 is configured in the same manner. Specifically, the securing members 8 are attached to portions 21e that are on the outer periphery 1e of the wound electrode assembly 1, among the negative uncoated portions 21b (the portions 21d), as shown in FIG. 7. In other words, the portions 21e are the negative uncoated portions 21b that are projecting, to Z2 side, from the negative coated portions 21a of the negative current collectors 21 that are wound on the radially outermost side of the wound electrode assembly 1. Note that FIG. 7 shows the securing members 8 in hatch patterns for clarity.

The securing members 8, as viewed from Z2 side, are also attached to multiple portions 21f, which are aligned radially inward relative to the portions 21e, among the negative uncoated portions 21b (the portions 21d). The portion 21f is the negative uncoated portion 21b that is projecting, to Z2 side, from the negative coated portion 21a that is wound radially inward than the negative coated portion 21a that is wound on the radially outermost side of the wound electrode assembly 1. In other words, the portion 21f projects from the negative coated portion 21a at a location more proximate to the winding axis α than a location at which the portion 21e projects from the negative coated portion 21a. Note that “as viewed from Z2 side” described above means viewing the wound electrode assembly 1 from a point P2 (see FIG. 5) on the winding axis α on Z2 side of the wound electrode assembly 1.

The securing members 8 are disposed across the radially aligned portion 21e and multiple portions 21f. This causes the portion 21e and the portions 21f to be adhered to each other by an adhesive layer 8d described below. Note that the negative uncoated portions 21b (the portion 21e and the portion 21f/the portions 21f) that are adjacent to each other in the radial direction partially overlap in Z direction.

Note that the locations and shapes of the securing members 8 on the end surface 1b are the same as the securing members 8 on the end surface 1a described above, and a repeated description is thus omitted.

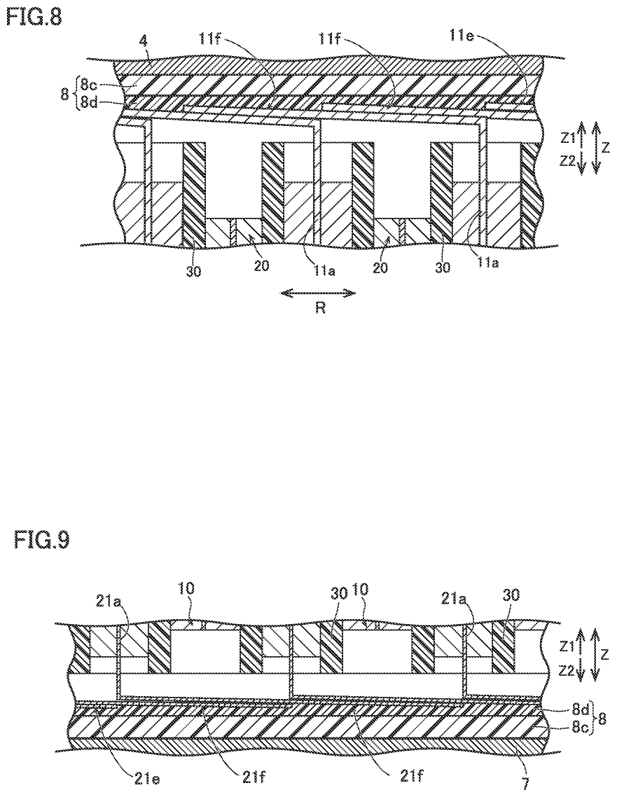

FIG. 8 is a cross-sectional view of the wound electrode assembly 1, taken long VIII-VIII line of FIG. 5. The securing member 8 includes a base member 8c and an adhesive layer 8d on the base member 8c. The adhesive layer 8d is applied to the surface of the base member 8c. The securing member 8 is disposed on the wound electrode assembly 1 with the adhesive layer 8d turned toward the wound electrode assembly 1 side (Z2 side). This causes the radially aligned positive uncoated portions 11b (the portion 11e and the portion 11f/the portions 11f) to be adhered to each other by the adhesive layer 8d. Note that the portions (11e, 11f) that are in contact with the securing member 8, are not in contact with the positive current collector plate 4.

FIG. 9 is a cross-sectional view of the wound electrode assembly 1, taken long IX-IX line of FIG. 5. The securing members 8 are disposed on the wound electrode assembly 1 with the adhesive layer 8d turned toward the wound electrode assembly 1 side (Z1 side). This causes the radially aligned negative uncoated portions 21b (the portion 21e and the portion 21f/the portions 21f) to be adhered to each other by the adhesive layer 8d. Note that the portions (21e, 21f) that are in contact with the securing member 8, are not in contact with the negative current collector plate 7.

In the present embodiment, the base member 8c is formed of an elastically deformable resin. In other words, the base member 8c is formed of a resin with a low elastic modulus. The type of the base member 8c is determined, taking into an account an amount of expansion of the wound electrode assembly 1 (e.g., the negative plate 20), etc. Specifically, the base member 8c is selected that can deform greater than or equal to such an amount of expansion (within an allowable range). For example, the base member 8c may be formed of an epoxy resin.

As described above, in the present embodiment, the securing members 8 are disposed on the end surface 1a (1b) of the wound electrode assembly 1. This allows the securing members 8 for maintaining the wound electrode assembly 1 in the wound state to be disposed on one side (the other side) in the axial direction of the wound electrode assembly 1 where a wider space is available. This can prevent the securing members 8 from interfering with the case 2 even if the wound electrode assembly 1 expands. As a result, the wound electrode assembly can be maintained in the wound state while inhibiting a local pressure from being produced at the wound electrode assembly.

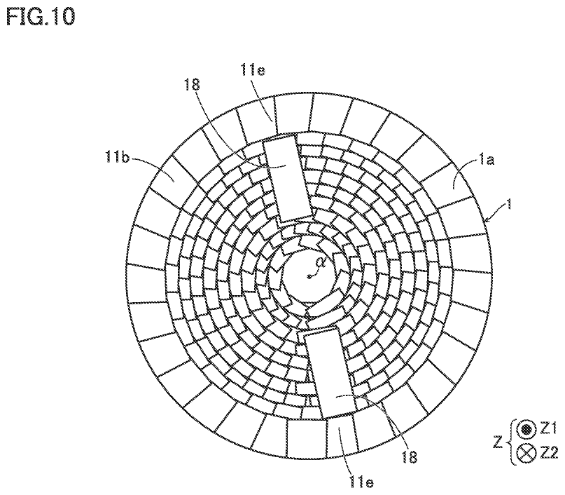

In the above embodiment, the securing members 8 are disposed on the portions 11e on the outer periphery 1e of the wound electrode assembly 1 (the termination portion 1d). However, the present disclosure is not limited thereto. The securing members 8 may not be disposed on the portions 11e on the outer periphery 1e (the termination portion 1d). For example, in the example shown in FIG. 10, securing members 18 are disposed radially more inward than the portions 11e on the outer periphery 1e. The negative side of the power storage cell 100 may be configured in the same manner.

In the above embodiment, the securing members 8 are disposed at locations closer to the peripheral surface 1c than the winding axis α. However, the present disclosure is not limited thereto. For example, securing members 28 may be disposed closer to the winding axis α than the peripheral surface 1c (the outer periphery 1e), as shown in FIG. 11. Note that the negative side of the power storage cell 100 may be configured in the same manner.

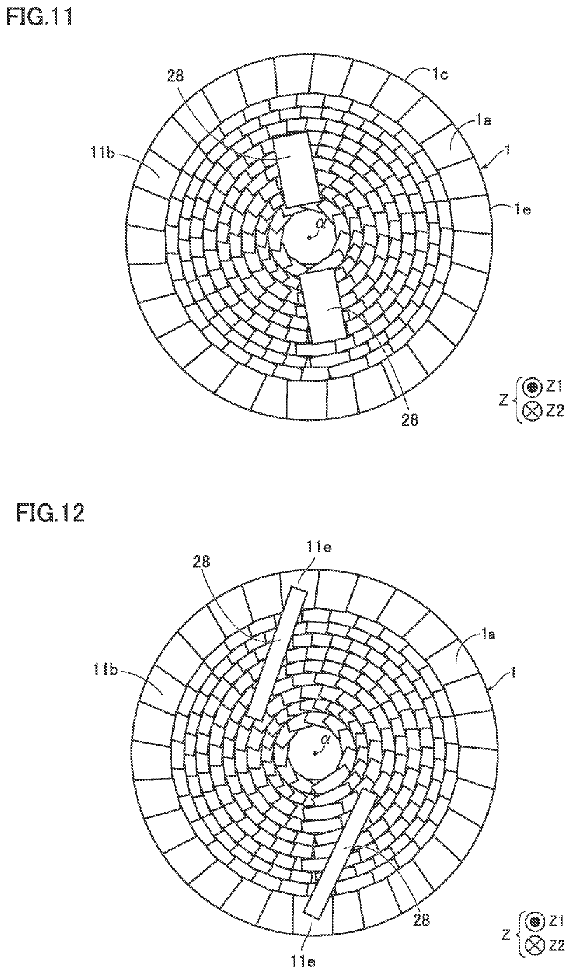

In the above embodiment, the securing members 8 extend in the radial direction. However, the present disclosure is not limited thereto. The securing members 8 may not extend in the radial direction. For example, in the example shown in FIG. 12, the securing members 8 extend in a direction intersecting with each of the radial direction and the circumference direction. Note that the negative side of the power storage cell 100 may be configured in the same manner.

In the above embodiment, the securing members 8, each having a rectangular shape, are formed linearly along the radial direction. However, the present disclosure is not limited thereto. For example, multiple securing members 38 may be radially aligned, as shown in FIG. 13. The securing members each may also be in a circular shape (e.g., a perfect circle, an ellipse, and an oblong circle), rather than a rectangular shape. Note that only one of the securing members 38 of FIG. 13 may be disposed.

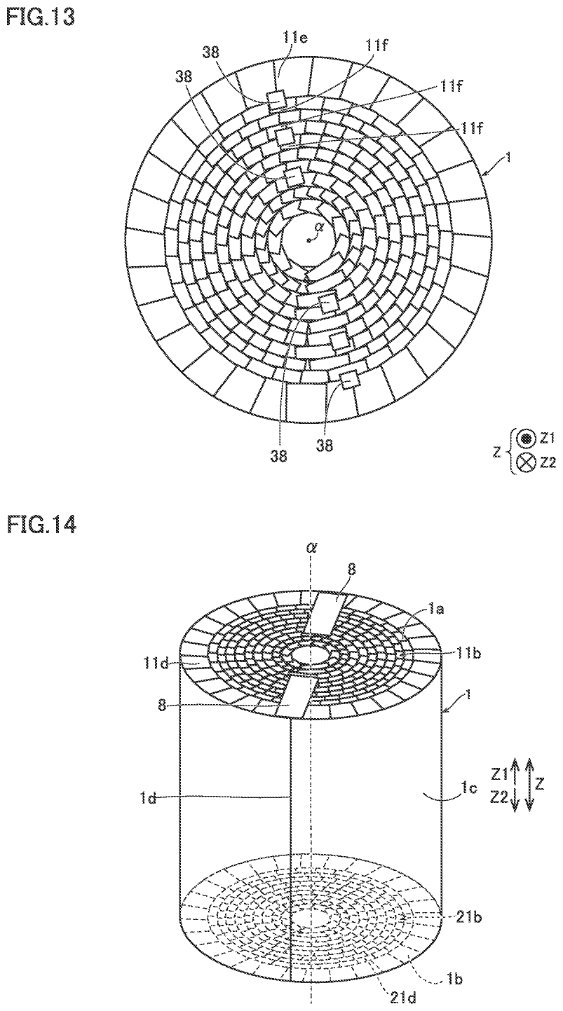

In the above embodiment, the securing members 8 are formed on the end surface 1a and the end surface 1b. However, the present disclosure is not limited thereto. The securing members 8 may be disposed only on one of the end surface 1a and the end surface 1b. FIG. 14 shows an example in which the securing members 8 are disposed only on the end surface 1a.

In the above embodiment, the securing members 8 are disposed on the tabless wound electrode assembly 1 in which the uncoated portions (11b, 21b) project in the axial direction from the coated portions (11a, 21a). However, the present disclosure is not limited thereto. As shown in FIG. 15, the securing members 8 may be disposed on a wound electrode assembly 31 that includes a positive plate 110 having a tab lead 111 attached thereto and a negative plate 120 having a tab lead 121 attached thereto.

In the above embodiment, the positive uncoated portion 11b and the negative uncoated portion 21b are bent radially inward. However, the present disclosure is not limited thereto. At least one of the positive uncoated portion 11b and the negative uncoated portion 21b may be bent radially outward.

In the above embodiment, the slit 11g is formed between the positive uncoated portions 11b. However, the present disclosure is not limited thereto. The slit may not be formed between the positive uncoated portions. In other words, the positive current collector may include a single positive uncoated portion wound about the winding axis α. The negative side of the power storage cell 100 may also have the same configuration.

In the above embodiment, the positive uncoated portions 11b, each including the portion 11c and the portion 11d, are provided. However, the present disclosure is not limited thereto. Multiple portions 11d may be connected to a single portion (a portion corresponding to the portion 11c) extending in the winding direction. The negative side of the power storage cell 100 may also have the same configuration.

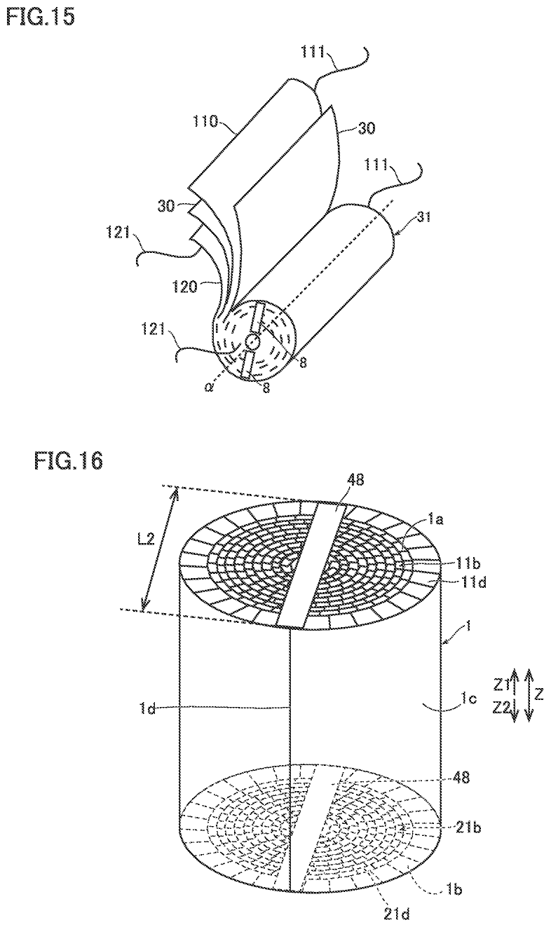

In the above embodiment, two securing members 8 are radially aligned. However, the present disclosure is not limited thereto. As shown in FIG. 16, one securing member 48 may radially extend, passing through the center of winding of the wound electrode assembly 1. Note that, preferably, the securing member 48 has a length L2, in the radial direction, which is 46 mm or less if the case 2 has the diameter r (see FIG. 1) of 46 mm. This enables the securing member 48 to be inhibited from interfering with the case 2.

Note that the embodiment and the respective variations thereof may be combined.

Although the embodiment according to the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell, comprising:
a wound electrode assembly which includes a first electrode, a second electrode, and a separator disposed between the first electrode and the second electrode; and
a securing member for securing the wound electrode assembly so that the wound electrode assembly is maintained in a wound state, wherein
the wound electrode assembly is configured of the first electrode, the second electrode, and the separator being wound about a winding axis,
the wound electrode assembly includes a first end surface on one side in an axial direction in which the winding axis extend, and a second end surface on the other side in the axial direction, and
the securing member is disposed at least on the first end surface.

2. The power storage cell according to claim 1, wherein
the securing member is disposed also on the second end surface.

3. The power storage cell according to claim 1, wherein
the wound electrode assembly includes a peripheral surface between the first end surface and the second end surface, and
the securing member is disposed closer to the peripheral surface than the winding axis.

4. The power storage cell according to claim 3, wherein
the securing member extends along a radial direction of the wound electrode assembly between the winding axis α nd the peripheral surface.

5. The power storage cell according to claim 4, further comprising
a case for accommodating the wound electrode assembly, the case having a cylindrical shape, wherein
the securing member has a length, in the radial direction, less than or equal to a radius of the case.

6. The power storage cell according to claim 1, wherein
the wound electrode assembly includes a termination portion where winding of the wound electrode assembly terminates, and
the securing member is disposed on the termination portion.

7. The power storage cell according to claim 1, wherein
as viewed from the axial direction, the wound electrode assembly includes an exposed portion where no securing member is disposed.

8. The power storage cell according to claim 1, wherein
the securing member includes a base member and an adhesive layer disposed on the base member, and
the base member is formed of an elastically deformable resin.

9. The power storage cell according to claim 1, wherein
the first electrode includes a first current collector and a first electrode material layer with which a portion of the first current collector is coated, the first electrode material layer facing the separator in a radial direction of the wound electrode assembly, wherein
the first current collector has:
a first coated portion that is coated with the first electrode material layer; and
a first uncoated portion that is not coated with the first electrode material layer, the first uncoated portion being located closer to the one side in the axial direction than the first coated portion, wherein
the securing member is disposed on the first end surface formed of the first uncoated portion.

10. The power storage cell according to claim 2, wherein
the second electrode includes a second current collector and a second electrode material layer with which a portion of the second current collector is coated, the second electrode material layer facing the separator in a radial direction of the wound electrode assembly, wherein
the second current collector has:
a second coated portion that is coated with the second electrode material layer; and
a second uncoated portion that is not coated with the second electrode material layer, the second uncoated portion being located closer to the other side in the axial direction than the second coated portion, wherein
the securing member is disposed on the second end surface formed of the second uncoated portion.
